(19) United States
(12) Patent Application Publication
(10) Pub. No.: US 2014/0104385 A1
(43) Pub. Date: Apr. 17, 2014

(54) METHOD AND APPARATUS FOR DETERMINING INFORMATION ASSOCIATED WITH A FOOD PRODUCT

(71) Applicants: SONY CORPORATION, Tokyo (JP); SONY NETWORK ENTERTAINMENT INTERNATIONAL LLC, Los Angeles, CA (US)

(72) Inventors: Ling Jun WONG, Champaign, IL (US); Charles McCOY, San Diego, CA (US); True XIONG, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/652,793

(22) Filed: Oct. 16, 2012

(51) Int. Cl. G06K 9/00; H04N 15/00

(52) U.S. Cl. 348/46; 382/110; 348/E15.001

(57) ABSTRACT

Certain aspects of an apparatus and method for determining information associated with a food product may include a server that is communicably coupled to a computing device. The server may deconstruct a three dimensional (3-D) image of the food product to identify one or more ingredients in the food product. Further, the server may compare the deconstructed 3-D image with a database of pre-stored images of food products to determine a type of the one or more ingredients in the food product. The server may determine nutritional information associated with the food product based on the determined type of the one or more ingredients.

### CROSS-REFERENCE TO RELATED APPLICATIONS/INCORPORATION BY REFERENCE

None.

### FIELD

Certain embodiments of the disclosure relate to communication devices. More specifically, certain embodiments of the disclosure relate to a method and apparatus to determine information associated with a food product.

### BACKGROUND

In some instances, food products may be prepared using a variety of ingredients based on the place of manufacturing of the food product. A food product made in Italy may not have the same ingredients as that of the same food product made in America. Further, the amount of ingredients in the food product made in Italy may vary from the amount of ingredients in the same food product made in America. People may also prefer some food products over others based on nutritional information associated with the food product.

Further limitations and disadvantages of conventional and traditional approaches will become apparent to one of skill in the art, through comparison of such systems with some aspects of the present disclosure as set forth in the remainder of the present application with reference to the drawings.

### SUMMARY

An apparatus and/or method is provided for determining information associated with a food product substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a server communicably coupled to a computing device to determine information associated with a food product, in accordance with an embodiment of the disclosure.

FIG. 2 is a block diagram of a computing device, in accordance with an embodiment of the disclosure.

FIG. 3 is a block diagram of a server, in accordance with an embodiment of the disclosure.

FIG. 4 is a flow chart illustrating exemplary steps for determining information associated with a food product at a server, in accordance with an embodiment of the disclosure.

FIG. 5 is a flow chart illustrating exemplary steps for associating metadata with a 3-D image at a computing device, in accordance with an embodiment of the disclosure.

FIG. 6 is a flow chart illustrating exemplary steps for determining information associated with a 3-D image of a food product using metadata, in accordance with an embodiment of the disclosure.

FIG. 7 is an exemplary user interface showing an input screen displayed on a computing device, in accordance with an embodiment of the disclosure.

FIG. 8 is an exemplary user interface showing an output screen displayed on a computing device, in accordance with an embodiment of the disclosure.

### DETAILED DESCRIPTION

Certain implementations may be found in an apparatus and/or method for determining information associated with a food product.

Exemplary aspects of the disclosure may comprise a server communicably coupled to one or more computing devices. In an embodiment, the server may receive a three dimensional (3-D) image, hereinafter referred to as “3-D image” of the food product from the one or more computing devices. The server may deconstruct the 3-D image of the food product to identify one or more ingredients in the food product. The deconstructed 3-D image may be compared with a database of pre-stored images of food products to determine a type of the one or more ingredients in the food product. Nutritional information associated with the food product may be determined based on the determined type of the one or more ingredients. The server may communicate the nutritional information associated with the food product for displaying on the one or more computing devices. The nutritional information associated with the food product corresponds to one or more of calorie information, at least one other food product having similar nutritional information as the food product, and/or at least one other food product having similar ingredients as the food product.

In an embodiment, the server may recommend at least one other food product based on the determined nutritional information. A type of one or more ingredients in the recommended at least one other food product may be similar to the determined type of the one or more ingredients in the food product. The type of one or more ingredients may correspond to one or more of carbohydrates, proteins, fats, fiber, cholesterol, sodium, vitamins, and/or minerals. In another embodiment, the server may receive the 3-D image of the food product and metadata associated with the 3-D image of the food product from the one or more computing devices. The metadata may correspond to one or more of a location data, a time of capturing the 3-D image, a name of the food product, a name of a restaurant serving the food product, and/or a location of the restaurant. The server may identify the one or more ingredients of the food product by comparing the 3-D image and the metadata with the database of pre-stored images of food products. Additionally, the server may receive an input corresponding to one or more of a name of the food product, a name of a restaurant serving the food product, and/or a location of the restaurant.

In another embodiment, the server may receive the 3-D image of the food product from the computing device. The server may compare the 3-D image with the database of pre-stored images of the food product to identify the one or more ingredients of the food product.

In another embodiment, the server may determine a freshness of the food product and/or a degree of cooking of the food product based on color information associated with the 3-D image of the food product. Further, the server may differentiate between one or more ingredients having similar shapes based on one or both of color information and/or color patterns associated with the 3-D image of the food product.

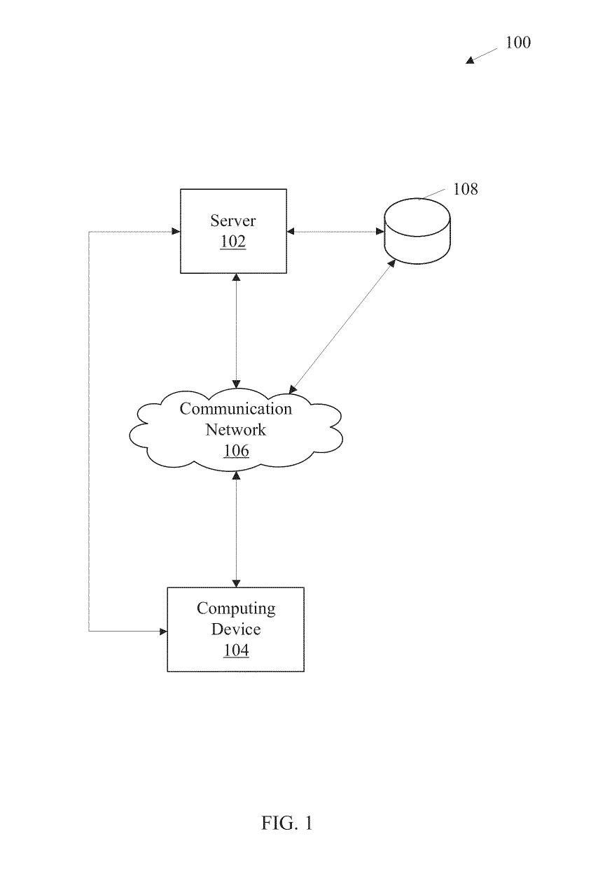

FIG. 1 is a block diagram illustrating a server communicably coupled to a computing device to determine information associated with a food product, in accordance with an embodiment of the disclosure. Referring to FIG. 1, there is shown a network environment 100. Network environment 100 may comprise a server 102, a computing device 104, a communication network 106, and a database 108. Notwithstanding, the disclosure may not be so limited and more than one computing device (such as the computing device 104) may be communicatively coupled to the server 102.

The server 102 may comprise suitable logic, circuitry, interfaces, and/or code that may enable communication with the computing device 104 directly or via the communication network 106. In an embodiment, the server 102 may be implemented as a cloud-based server and/or a web-based server.

The computing device 104 may be a camera and/or a smartphone having a camera, for example. Notwithstanding, the disclosure may not be so limited and other types of computing devices may be communicatively coupled to the server 102 without limiting the scope of the disclosure. In an embodiment, the computing device 104 may be capable of transmitting and/or receiving instructions and commands to the server 102 based on a user input. In another embodiment, the computing device 104 may be capable of automatically transmitting and/or receiving instructions and commands to the server 102. The computing device 104 may implement various communication protocols for transmission and/or reception of data and instructions via the communication network 106.

The communication network 106 may include a medium through which one or more computing devices (such as the computing device 104, for example) in the network environment 100 may communicate with each other. Examples of the communication network 106 may be enabled by one or more communication protocols which include, but are not limited to, the Internet, Wireless Fidelity (Wi-Fi) network, Wireless Local Area Network (WLAN), Local Area Network (LAN), Metropolitan Area Network (MAN), ZigBee, TCP/IP, and/or Ethernet, for example. Various devices in the network environment 100 may be operable to connect to the communication network 106 in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, Infra Red (IR), IEEE 802.11, 802.16, cellular communication protocols, and/or Bluetooth (BT) communication protocols.

The database 108 may comprise suitable logic, circuitry, interfaces, and/or code that may be operable to store a plurality of 3-D images of food products, the information associated with the food product, any data associated with the server 102, any data associated with the computing device 104, and/or any other data. In an embodiment, the database 108 may connect to the server 102 through the communication network 106. In another embodiment, the database 108 may be integrated with the server 102. The computing device 104 may communicate with the database 108 through the communication network 106. The database 108 may be implemented by using several technologies that are well known to those skilled in the art. Some examples of technologies may include, but are not limited to, MySQL® and Microsoft SQL®.

In operation, the server 102 may receive a 3-D image of a food product from the computing device 104. The server 102 may deconstruct the 3-D image of the food product to identify one or more ingredients in the food product. The server 102 may compare the deconstructed 3-D image with pre-stored images of food products stored in the database 108. The server 102 may determine a type of the one or more ingredients in the food product based on the comparison. The determined type of the one or more ingredients may be used to determine nutritional information associated with the food product. In an embodiment, the nutritional information associated with the food product, may include, but is not limited to, a name, the one or more ingredients, caloric value, at least one other food product with similar ingredients, at least one other food product with similar nutritional information, origin, recipe, serving instructions, shelf life, preservatives, amount of ingredients, price variation across places, reviews, recipe of the food product, other recipes having similar ingredients, and/or allergy information. The nutritional information may be displayed on the computing device 104. Notwithstanding, the disclosure may not be so limited and other display devices associated with the computing device 104 may be utilized to display the nutritional information without limiting the scope of the disclosure.

In an embodiment, the computing device 104 may associate metadata with the 3-D image. Further, the computing device 104 may communicate the 3-D image and the metadata associated with the 3-D image to the server 102. The server 102 may receive the 3-D image and the metadata associated with 3-D image. The server 102 may store the received 3-D image and the metadata associated with 3-D image in memory 304 and/or database 108. The server 102 may utilize such metadata to identify the one or more ingredients. In an embodiment, the metadata may be a location data of the user, a time of capture of the 3-D image, a name of the food product, a name of a restaurant serving the food product, or a location of the restaurant. The server 102 then utilizes the metadata associated with the 3-D image to identify the one or more ingredients of the food product.

In an embodiment, the server 102 may receive the metadata from the user via the computing device 104. The user may use an input device associated with the computing device 104 to enter the metadata. In another embodiment, the computing device 104 may automatically generate the metadata. For example, a Global Positioning System (GPS) associated with the computing device 104 (such as in the smartphone, for example) may provide a location data of the user. In an embodiment, the computing device 104 (such as the camera, for example) may have the capability to determine the time of capture of the 3-D image. The computing device 104 may associate the metadata with the 3-D image and communicate it to the server 102. The server 102 may receive the 3-D image and the metadata associated with the 3-D image to identify the one or more ingredients of the food product.

In an embodiment, the computing device 104 may communicate the captured 3-D image to the server 102 via an intermediate device having computational capabilities, such as, a laptop, for example. The computing device 104 may communicate with the intermediate device through any near field communication technologies, such as, Bluetooth. Further, the intermediate device may in turn communicate with the server 102 via the communication network 106.

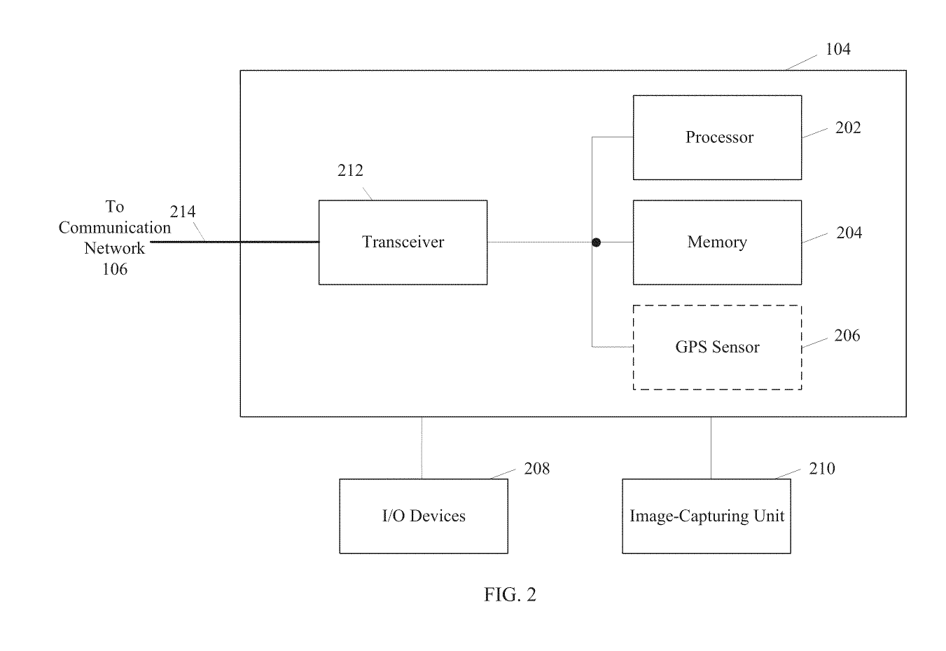

FIG. 2 is a block diagram of a computing device, in accordance with an embodiment of the disclosure. FIG. 2 is explained in conjunction with elements from FIG. 1. Referring to FIG. 2, there is shown the computing device 104. The computing device 104 may comprise a processor 202, a memory 204, a Global Positioning System (GPS) sensor 206, Input-Output (I/O) devices 208, an image-capturing unit 210, a transceiver 212, and a communication interface 214.

The processor 202 may be communicatively coupled to the memory 204, the GPS sensor 206, the I/O devices 208, and the image-capturing unit 210. Further, the transceiver 212 may be communicatively coupled to the processor 202, the memory 204, the I/O devices 208, and the image-capturing unit 210.

The processor 202 may comprise suitable logic, circuitry, interfaces, and/or code that may be operable to execute a set of instructions stored in the memory 204. The processor 202 may be implemented based on a number of processor technologies known in the art. Examples of processor 202 may be an X86-based processor, a RISC processor, an ASIC processor, a CISC processor, or any other processor.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a secure digital (SD) card.

The GPS sensor 206 may comprise suitable logic, circuitry, interfaces, and/or code that may be operable to provide a location of the user operating the computing device 104. In an embodiment, the GPS sensor 206 may be integrated with the computing device 104. In another embodiment, the GPS sensor 206 may be external to the computing device 104. The GPS sensor 206 may be communicably coupled to the computing device 104.

The I/O devices 208 may comprise various input and output devices operably coupled to the processor 202. Examples of input devices include, but are not limited to, a keyboard, a mouse, a joystick, a touch screen, a stylus, and/or a microphone. Examples of output devices include, but are not limited to, a display and/or a speaker. In an embodiment, a user input may include metadata, one or more of user defined settings, user preferences, device preferences, device ID, set of instructions, a user ID, a password, a visual input, an audio input, a gesture input, a voice command, a touch input, a location input, a text input, a face image, and/or a fingerprint image.

The image-capturing unit 210 may comprise suitable logic, circuitry, interfaces, and/or code that may be operable to capture a 3-D image of a food product upon receiving instructions from the processor 202. The image-capturing unit 210 may be integrated with one or more of a camera, a smartphone, a laptop, or a personal digital assistant (PDA).

The transceiver 212 may comprise suitable logic, circuitry, interfaces, and/or code that may be operable to communicate with the server 102 via the communication interface 214. In an embodiment, the transceiver 212 may be operable to communicate with the server 102. The transceiver 212 may implement known technologies for supporting wired or wireless communication with the communication network 106.

In operation, the processor 202 may be operable to register the computing device 104 with the server 102 to facilitate communication with the server 102. A user interface (UI) may be provided to the user of the I/O devices 208 (for example, a display screen). The image-capturing unit 210 may capture the 3-D image of the food product. The processor may be operable to communicate the 3-D image to the server 102. In an embodiment, communication of the 3-D image may be automated, and/or may be based on one or more user inputs, such as a voice command, for example.

In an embodiment, the user may use the input device of the I/O devices 208 (for example, a keypad) to input a name of the food product. The GPS sensor 206 may be operable to provide the location data of the user operating the computing device 104. The processor 202 may be operable to associate the 3-D image with the location data and the name of the food product. Further, the processor 202 may be operable to communicate the 3-D image associated with the location data and the name of the food product to the server 102.

In an embodiment, the processor 202 may recommend one or more of at least one other food product similar to a type of one or more ingredients in the food product, alternate ingredients of the food product, a location to purchase the alternate ingredients, one or more restaurants serving the food product, and/or one or more grocery stores to purchase one or more ingredients in the food product.

In an embodiment, the processor 202 may recommend one or more other food products to the user based on the determined nutritional information. In such a case, the one or more other food products may be displayed to the user. The user may select one of the displayed food products to obtain the nutritional information associated with the corresponding one of the one or more other food products.

In another embodiment, the processor 202 may provide opportunities for the user to purchase one or more of the recommended at least one other food product similar to a type of one or more ingredients in the food product, the one or more ingredients in the food product, and/or alternate ingredients of the food product. For example, the user may be provided with one or more grocery stores that may sell the recommended at least one other food product similar to the type of the one or more ingredients in the food product. The user may also be provided with one or more grocery stores that may sell one or more ingredients in the food product and/or the alternate ingredients of the food product. In an embodiment, the one or more grocery stores may be in certain proximity to the user.

In an embodiment, the image-capturing unit 210 may be calibrated to determine a difference in one or more of color balance, lighting, and/or exposure between the captured 3-D image of the food product and a reference 3-D image of a reference object, such as a food product. The reference 3-D image of the food product may have solid grey pixels of known darkness, for example. The image-capturing unit 210 may be calibrated based on capturing a 3-D image of the reference object. Further, the processor 202 may be operable to adjust for any color difference between pixels associated with the captured 3-D image of the food product and the solid grey pixels of known darkness associated with the reference 3-D image of the food product. The color difference between the pixels may be communicated to the server 102.

In general, the server 102 may be operable to store a sample 3-D image of the food product that has sample color information and may accurately define color information associated with the food product. The server 102 may be operable to compare the communicated color difference with the sample color information in order to determine one or both of a freshness of the food product and/or a degree of cooking of the food product. For example, a dark colored caramel may imply that the caramel was cooked for a longer duration in comparison to a light colored caramel that may imply that the caramel was cooked for a shorter duration.

Further, the color information and/or color patterns associated with the captured 3-D image of the food product may be used to differentiate between one or more ingredients of the food product having similar shapes by calibrating the image-capturing unit 210. For example, food products such as, a brown bread sandwich and a white bread sandwich may have similar shapes but with different ingredients. Therefore, the server 102 may use the color information and/or the color patterns associated with the food products to determine one or more ingredients associated with the food product. Alternatively, one or more ingredients of the food product may also be determined without calibrating the image-capturing unit 210. However, calibrating the image-capturing unit 210 for color may provide better results.

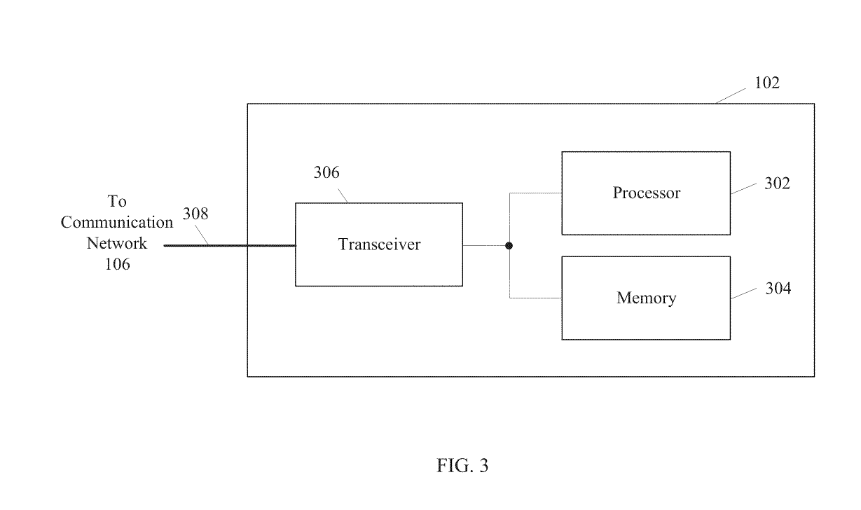

FIG. 3 is a block diagram of a server, in accordance with an embodiment of the disclosure. FIG. 3 is explained in conjunction with elements from FIG. 1. Referring to FIG. 2, there is shown the server 102. The server 102 may comprise a processor 302, a memory 304, a transceiver 306, and a communication interface 308.

The processor 302 may be communicatively coupled to the memory 304. Further, the transceiver 306 may be communicatively coupled to the processor 302, and the memory 304.

The processor 302 may comprise suitable logic, circuitry, interfaces, and/or code that may be operable to execute a set of instructions stored in the memory 304. The processor 302 may be implemented based on a number of processor technologies known in the art. Examples of processor 302 may be an X86-based processor, a RISC processor, an ASIC processor, a CISC processor, or any other processor.

The memory 304 may comprise suitable logic, circuitry, interfaces, and/or code that may be operable to store the received set of instructions. The memory 304 may be implemented based on, but not limited to, a Random Access Memory (RAM), a Read-Only Memory (ROM), a Hard Disk Drive (HDD), a storage server and/or a secure digital (SD) card.

In an embodiment, the database 108 may be integrated with the memory 304. The database 108 and/or the memory 304 may store pre-stored images of food products. The database 108 and/or the memory 304 may be populated as and when one or more users search for nutritional information regarding one or more food products by capturing one or more 3-D images and communicating the 3-D images to the server 102.

The transceiver 306 may comprise suitable logic, circuitry, interfaces, and/or code that may be operable to communicate with the computing device 104 via the communication interface 308. In an embodiment, the transceiver 306 may be operable to communicate with the computing device 104. The transceiver 306 may implement known technologies for supporting wired or wireless communication with the communication network 106.

In operation, the processor 302 may be operable to register the computing device 104 to facilitate communication with the computing device 104. The processor 302 may be operable to receive a 3-D image of a food product from the computing device 104. In an embodiment, the food product may correspond to one or more of a prepared meal, a packaged food, a beverage, and/or a meal served at a restaurant. The processor 302 may be operable to deconstruct the 3-D image of the food product to identify one or more ingredients in the food product. The processor 302 may be operable to compare the deconstructed 3-D image with the pre-stored images of food products stored in the database 108. The processor 302 may determine a type of the one or more ingredients in the food product based on the comparison. The processor 302 may be operable to use the determined type of the one or more ingredients to determine nutritional information associated with the food product. Further, the processor 302 may be operable to communicate the nutritional information associated with the food product via the transceiver 306. The output device of the I/O devices 208 (refer to FIG. 2) may display the nutritional information to the user. Notwithstanding, the disclosure may not be so limited and other display devices associated with computing device 104 may be utilized to display the nutritional information without limiting the scope of the disclosure.

In an embodiment, the deconstruction may be performed by separating the 3-D image into a foreground image and a background image. The processor 302 may filter the foreground image and the background image and may further detect one or more edges present in the foreground image and the background image. Further, the processor 302 may perform passive separation of one or more objects indicated by the one or more edges. The processor 302 may scan the one or more objects separately. The one or more objects may be compared with the pre-stored images of food products stored in the database 108 so as to identify the one or more ingredients in the food product.

In an embodiment, a threshold may be defined for comparing the 3-D image with the pre-stored images of food products. For example, a 3-D image of a packaged food manufactured by Company A may not be similar to a 3-D image of the same packaged food manufactured by company B. Therefore, an exact match may not be possible to determine the nutritional information associated with the packaged food. Hence, the threshold may be defined based on the type of food product, such as, packaged food, and/or home cooked food, for example.

In an embodiment, the processor 302 may be operable to receive the metadata, for example, the location data and/or the name of the food product associated with the 3-D image of the food product communicated by the computing device 104. In an embodiment, the metadata may include a location data, a time of capture of the 3-D image, a name of the food product, a name of a restaurant serving the food product, or a location of the restaurant. The processor 302 may be operable to identify the one or more ingredients of the food product based on the metadata associated with the 3-D image.

In an embodiment, the processor 302 may be operable to store the captured 3-D image at the memory 304. In another embodiment, the 3-D image and the metadata associated with the 3-D image may be stored in the memory 304. Subsequently, the memory 304 and/or the database 108 may be updated based on newly received images of food products and metadata.

In an embodiment, the processor 302 may recommend at least one other food product based on the determined nutritional information. A type of one or more ingredients in the recommended food product(s) may be similar to the determined type of the one or more ingredients in the food product. The processor 302 may communicate the recommended at least one other food product to the computing device 104.

In an embodiment, the user may want to obtain location-based nutritional information associated with the food product. In such a case, the user may capture a 3-D image of the food product using the computing device 104. Further, the user may input the location for which the nutritional information associated with the food product needs to be determined. The processor 202 may be operable to associate the location with the 3-D image of the food product and communicate the same to the server 102. The processor 302 may be operable to compare the 3-D image of the food product with the pre-stored images of food products based on the location specified by the user. The processor 302 may determine nutritional information associated with the food product based on the location. The nutritional information may be displayed to the user of the computing device 104. For example, a user located in New York may want to find the ingredients of the 3-D image of Pasta made in Italy. In such a case, the user may input the location as Italy or provide GPS coordinates of a specific location. The processor 202 may associate the 3-D image with the metadata (Italy, for example) and communicate the same to the server 102. The server 102 may compare the 3-D image with the pre-stored images of food products. Further, the server 102 may determine the one or more ingredients of the food product (Pasta, for example) based on the location (Italy, for example).

In an embodiment, the processor 302 may be operable to advise the user about the one or more ingredients of the food product to which the user may be allergic. For example, a user may be allergic to peanuts. In such a case, the processor 302 may be operable to advise the user of the presence of peanuts within the food product. In an embodiment, the user may configure a list associated with a profile of the user to include one or more ingredients to which the user may be allergic. The processor 302 may also facilitate the user in revising the list of one or more ingredients to which the user may be allergic.

In an embodiment, the processor 302 may be operable to identify missing ingredients of the food product associated with the 3-D image. The processor 302 may be operable to identify missing ingredients by cross-referencing the identified one or more ingredients of the food product with pre-stored metadata associated with the pre-stored images.

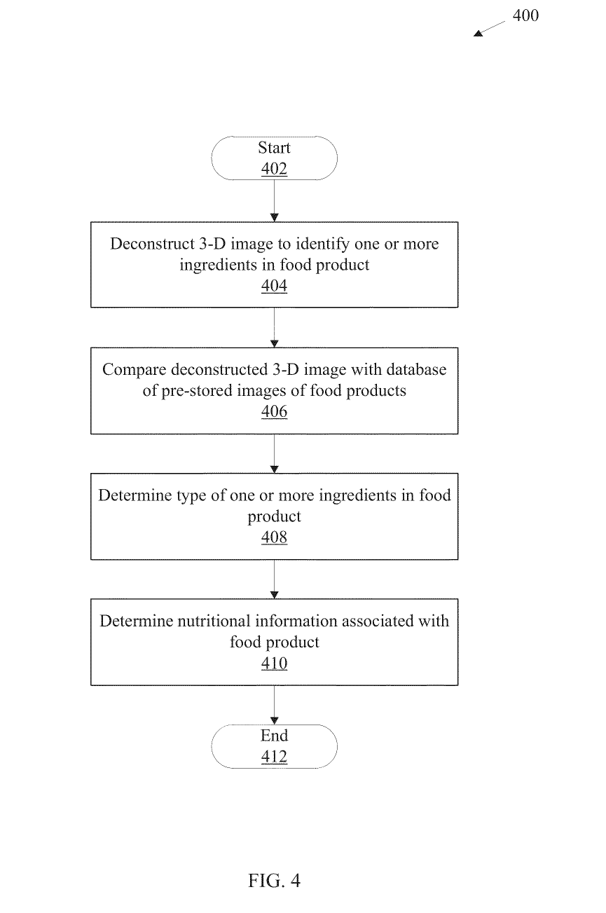

FIG. 4 is a flow chart illustrating exemplary steps for determining information associated with a food product at a server, in accordance with an embodiment of the disclosure. Referring to FIG. 4, there is shown a method 400. The method 400 is described in conjunction with the elements of FIG. 1, FIG. 2, and FIG. 3.

Exemplary steps may begin at step 402. At step 404, the processor 302 may deconstruct the 3-D image received from the computing device 104. The processor 302 may identify the one or more ingredients of the food product by processing the 3-D image using one or more image processing algorithms.

At step 406, the processor 302 may compare the deconstructed 3-D image with the pre-stored images of food products stored in the database 108. The processor 302 may find one or more matches for the food product from the pre-stored images of food products. At step 408, the processor 302 may determine the type of one or more ingredients in the food product based on the one or more matches obtained for the food product. The type of one or more ingredients may correspond to one or more of carbohydrates, proteins, fats, fiber, cholesterol, sodium, vitamins, and/or minerals. In an embodiment, the type of one or more ingredients may comprise an amount of carbohydrates, proteins, vitamins, minerals, and/or other ingredients in the food product.

At step 410, the processor 302 may determine nutritional information associated with the food product. In an embodiment, the nutritional information associated with the food product, may include, but is not limited to, caloric value, at least one other food product with similar ingredients, at least one other food product with similar nutritional information, origin, recipe, serving instructions, shelf life, preservatives, amount of ingredients, price variation across places, reviews, recipe of the food product, other recipes having similar ingredients, and/or allergy information. Further the processor 302 may communicate via the transceiver 306, the nutritional information to the computing device 104. The method 400 ends at step 412.

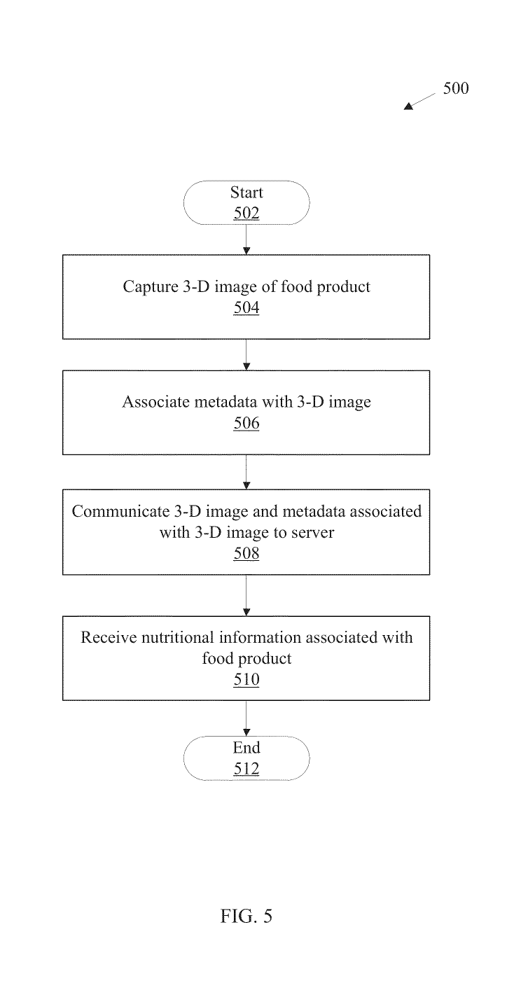

FIG. 5 is a flow chart illustrating exemplary steps for associating metadata with a 3-D image at a computing device, in accordance with an embodiment of the disclosure. Referring to FIG. 5, there is shown a method 500. The method 500 is described in conjunction with the elements of FIG. 1, FIG. 2, FIG. 3, and FIG. 4.

Exemplary steps may begin at step 502. At step 504, the processor 202 may capture the 3-D image of a food product via the image-capturing unit 210.

At step 506, the processor 202 may associate the metadata with the 3-D image. In an embodiment, the metadata (the location data of the user, for example), may be received from the user via the input device of the I/O devices 208. In another embodiment, the location data of the user may be automatically identified by the GPS sensor 206. At step 508, the processor 202 may communicate via the transceiver 212, the 3-D image and the metadata associated with the 3-D image to the server 102. At step 510, the processor 202 may receive nutritional information associated with the food product based on the communicated metadata associated with the 3-D image from server 102. The method 500 ends at step 512.

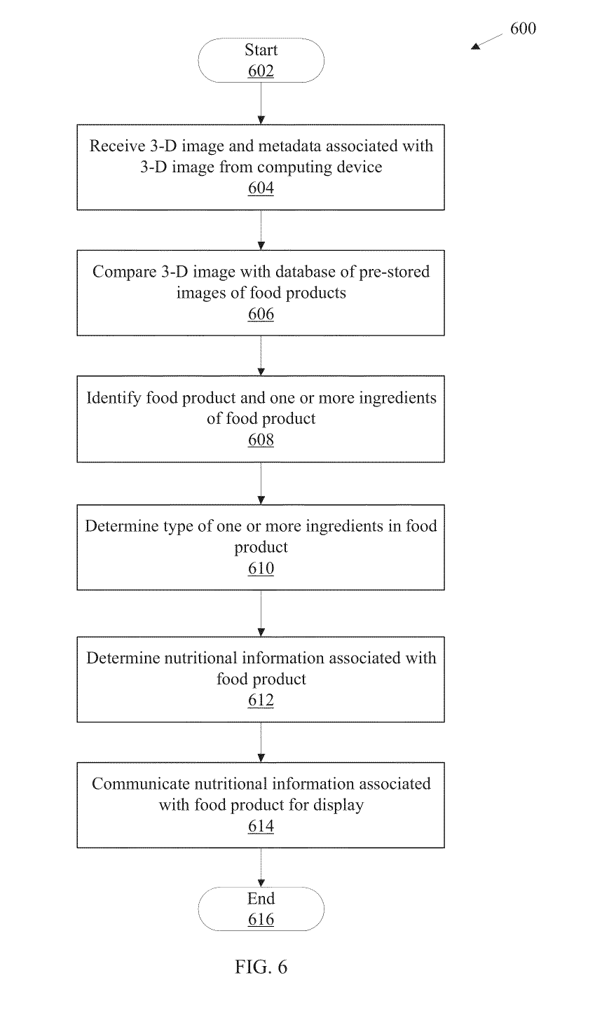

FIG. 6 is a flow chart illustrating exemplary steps for determining information associated with a 3-D image of a food product using metadata, in accordance with an embodiment of the disclosure. Referring to FIG. 6, there is shown a method 600. The method 600 is described in conjunction with the elements of FIG. 1, FIG. 2, FIG. 3, FIG. 4, and FIG. 5.

Exemplary steps may begin at step 602. At step 604, the processor 302 may receive the 3-D image of a food product and the metadata associated with the 3-D image from the computing device 104.

At step 606, the processor 302 may in an embodiment, compare the 3-D image with the pre-stored images of food products based on the associated metadata. For example, the processor 302 may utilize the location data of the user to identify the food product. At step 608, the processor 302 may identify the food product and the one or more ingredients of the food product. For example, the processor 302 may identify that the food product may be a hamburger and the ingredients of the hamburger may be meat, bread, tomatoes, lettuce and cheese. At step 610, the processor 302 may determine a type of the one or more ingredients in the food product. For example, the processor 302 may determine the presence of carbohydrates, fats, and/or proteins in the hamburger.

At step 612, the processor 302 may determine the nutritional information associated with the food product. Such nutritional information associated with the food product may include, but is not limited to, a name, the one or more ingredients, caloric value, at least one other food product with similar ingredients, at least one other food product with similar nutritional information, origin, recipe, serving instructions, shelf life, preservatives, amount of ingredients, price variation across places, reviews, recipe of the food product, other recipes having similar ingredients, and/or allergy information. At step 614, the processor 302 may communicate the nutritional information associated with the food product to the computing device 104 for display. The method 600 ends at step 614.

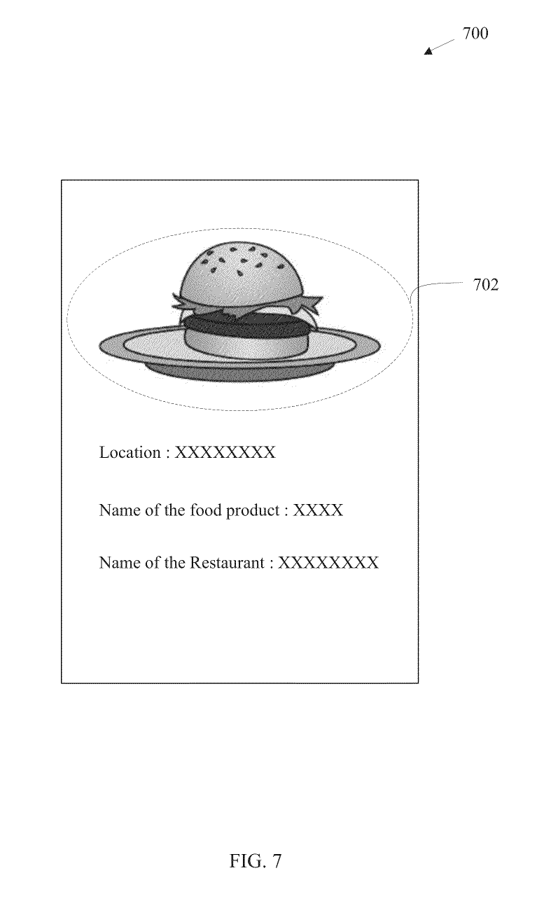

FIG. 7 is an exemplary user interface showing an input screen displayed on a computing device, in accordance with an embodiment of the disclosure. Further, FIG. 7 is explained in conjunction with FIG. 1, FIG. 2, and FIG. 3. Referring to FIG. 7, there is shown an input screen 700 associated with the computing device 104. In an embodiment, the user via the computing device 104 may capture a 3-D image 702 of a food product. The 3-D image 702 may be displayed on the input screen 700. Further, the user may input metadata associated with the food product via the user interface displayed on the input screen 700. The metadata may include, but is not limited to, a location of the user, a name of the food product, and/or a name of a restaurant serving the food product. In an embodiment, the nutritional information associated with the food product may be tagged as metadata of the food product. The computing device 104 may be operable to associate the metadata with the 3-D image 702. Further, the computing device 104 may be operable to communicate the 3-D image 702 and the metadata associated with the 3-D image 702 to the server 102 via the communication network 106.

In an embodiment, the user may not enter the metadata. In such a case, the 3-D image 702 may be communicated to the server 102 without associating the metadata.

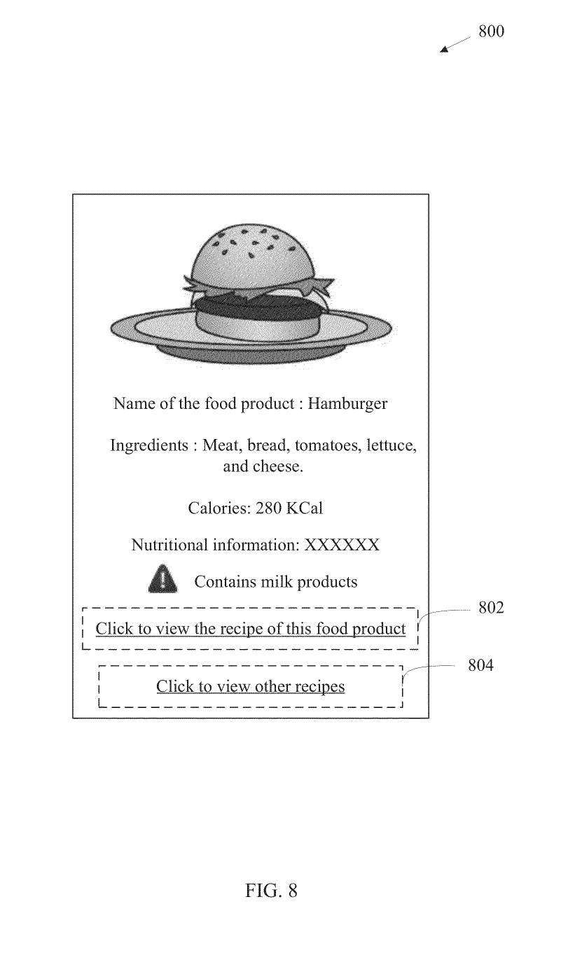

FIG. 8 is an exemplary user interface showing an output screen displayed on a computing device, in accordance with an embodiment of the disclosure. Further, FIG. 8 is explained in conjunction with FIG. 1, FIG. 2, FIG. 3, and FIG. 7. Referring to FIG. 8, there is shown an output screen 800 associated with the computing device 104. In an embodiment, the server 102 may receive the 3-D image 702 and the metadata associated with the 3-D image 702 communicated by the computing device 104. The server 102 may compare the 3-D image 702 with the pre-stored images of food products stored in the memory 304 and/or database 108. The server 102 may identify the food product and one or more ingredients in the food product based on the comparison. Further, the server 102 may determine the nutritional information associated with the 3-D image 702 of the food product. Such nutritional information associated with the food product may include, but is not limited to, a name, the one or more ingredients, caloric value, at least one other food product with similar ingredients, at least one other food product with similar nutritional information, origin, recipe, serving instructions, shelf life, preservatives, amount of ingredients, price variation across places, reviews, recipe of the food product, other recipes having similar ingredients, and/or allergy information. Further, the nutritional information determined by the server 102 may be communicated to the computing device 104 for display. The output screen 800 may display the nutritional information on the display associated with the computing device 104 as shown in FIG. 8. Further, the output screen 800 may include links to view the recipe of the food product (see region 802). The output screen 800 may also include links to view other recipes having similar ingredients as that of the food product (see region 804).

In accordance with another embodiment of the disclosure, a method and apparatus for determining information associated with a food product may comprise a server 102 (FIG. 1) communicably coupled to one or more computing devices (such as a computing device 104 (FIG. 1)). One or more processors and/or circuits in the server 102, for example, the processor 302 (FIG. 3) may be operable to receive a 3-D image of the food product from a computing device 104 via the communication network 106 (FIG. 1). The server 102 may be operable to deconstruct the received 3-D image of the food product to identify one or more ingredients in the food product. The server 102 may be operable to compare the deconstructed 3-D image with a database of pre-stored images of food products to determine a type of the one or more ingredients in the food product. The server 102 may be further operable to determine nutritional information associated with the food product based on the determined type of the one or more ingredients. The nutritional information corresponds to one or more of calorie information, at least one other food product having similar nutritional information as the food product, and/or at least one other food product having similar ingredients as the food product.

In an embodiment, the server 102 may receive the 3-D image of the food product and metadata associated with the 3-D image of the food product from the computing device 104. The metadata may correspond to one or more of a location data, a time of capturing the 3-D image, a name of the food product, a name of a restaurant serving the food product, and/or a location of the restaurant. Additionally, the server 102 may receive an input corresponding to one or more of a name of the food product, a name of a restaurant serving the food product, and/or a location of the restaurant. The server 102 may identify the one or more ingredients of the food product by comparing the 3-D image and the metadata with the database of pre-stored images of food products.

In yet another embodiment, the server 102 may receive the 3-D image of the food product from the one or more computing devices (such as the computing device 104). The server 102 may compare the 3-D image with a database of pre-stored images of the food product to identify the one or more ingredients of the food product.

In accordance with yet another embodiment of the disclosure, a method and apparatus for determining information associated with a food product may comprise a computing device 104 (FIG. 1) communicably coupled to a server 102 (FIG. 1). One or more processors and/or circuits in the computing device 104, for example, the processor 202 (FIG. 2) may be operable to capture a 3-D image. The computing device 104 may communicate the captured 3-D image and/or metadata associated with the 3-D image to the server 102. The computing device 104 may receive nutritional information associated with the food product based on the communicated metadata associated with the 3-D image. The metadata may correspond to one or more of a location data, a time of capturing the 3-D image, a name of the food product, a name of a restaurant serving the food product, and/or a location of the restaurant. Further, the computing device 104 may recommend one or more of at least one other food product similar to a type of one or more ingredients in the food product, alternate ingredients of the food product, a location to purchase the alternate ingredients, one or more restaurants serving the food product, and/or one or more grocery stores to purchase one or more ingredients in the food product.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps comprising a server receiving a 3-D image of a food product from a computing device. The steps further comprise deconstructing the 3-D image of the food product to identify one or more ingredients in the food product. The deconstructed 3-D image may be compared with a database of pre-stored images of food products to determine a type of the one or more ingredients in the food product. The nutritional information associated with the food product may be determined based on the determined type of the one or more ingredients.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for determining information associated with a food product, said method comprising:
in a server communicably coupled to one or more computing devices:
deconstructing a three dimensional (3-D) image of said food product to identify one or more ingredients in said food product;
comparing said deconstructed 3-D image with a database of pre-stored images of food products to determine a type of said one or more ingredients in said food product; and
determining nutritional information associated with said food product based on said determined type of said one or more ingredients.

2. The method of claim 1, comprising receiving said 3-D image of said food product from said one or more computing devices.

3. The method of claim 1, comprising receiving said 3-D image and metadata associated with said 3-D image to identify said one or more ingredients.

4. The method of claim 3, wherein said metadata corresponds to one or more of: a location data, a time of capturing said 3-D image, a name of said food product, a name of a restaurant serving said food product, and/or a location of said restaurant.

5. The method of claim 1, comprising comparing said 3-D image with said database of said pre-stored images to identify said one or more ingredients of said food product.

6. The method of claim 1, comprising communicating said nutritional information associated with said food product for display on said one or more computing devices.

7. The method of claim 1, comprising recommending at least one other food product based on said determined nutritional information.

8. The method of claim 7, wherein a type of one or more ingredients in said recommended said at least one other food product is similar to said determined type of said one or more ingredients in said food product.

9. The method of claim 1, wherein said type of said one or more ingredients correspond to one or more of: carbohydrates, proteins, fats, fiber, cholesterol, sodium, vitamins, and/or minerals.

10. The method of claim 1, wherein said nutritional information associated with said food product corresponds to one or more of: calorie information, at least one other food product having similar nutritional information as said food product, and/or at least one other food product having similar ingredients as said food product.

11. The method of claim 1, comprising receiving an input corresponding to one or more of: a name of said food product, a name of a restaurant serving said food product, and/or a location of said restaurant.

12. The method of claim 1, comprising determining one or more of: a freshness of said food product and/or a degree of cooking of said food product based on color information associated with said 3-D image of said food product.

13. The method of claim 1, comprising differentiating between said one or more ingredients having similar shapes based on one or both of: color information and/or color patterns associated with said 3-D image of said food product.

14. An apparatus for determining information associated with a food product, said apparatus comprising:
in a server communicably coupled to one or more computing devices, one or more processors and/or circuits in said server being operable to:
deconstruct a three dimensional (3-D) image of said food product to identify one or more ingredients in said food product;
compare said deconstructed 3-D image with a database of pre-stored images of food products to determine a type of said one or more ingredients in said food product; and
determine nutritional information associated with said food product based on said determined type of said one or more ingredients.

15. The apparatus of claim 14, wherein said one or more processors and/or circuits are operable to receive said 3-D image of said food product from said one or more computing devices.

16. The apparatus of claim 14, wherein said one or more processors and/or circuits are operable to receive said 3-D image and metadata associated with said 3-D image to identify said one or more ingredients.

17. The apparatus of claim 16, wherein said metadata corresponds to one or more of: a location data, a time of capturing said 3-D image, a name of said food product, a name of a restaurant serving said food product, and/or a location of said restaurant.

18. The apparatus of claim 14, wherein said one or more processors and/or circuits are operable to compare said 3-D image with said database of said pre-stored images to identify said one or more ingredients of said food product.

19. The apparatus of claim 14, wherein said nutritional information associated with said food product corresponds to one or more of: calorie information, at least one other food product having similar nutritional information as said food product, and/or at least one other food product having similar ingredients as said food product.

20. The apparatus of claim 14, wherein said one or more processors and/or circuits are operable to receive an input corresponding to one or more of: a name of said food product, a name of a restaurant serving said food product, and/or a location of said restaurant.

21. An apparatus for determining information associated with a food product, said apparatus comprising:
in a computing device communicably coupled to a server, one or more processors and/or circuits in said computing device being operable to:
capture a three dimensional (3-D) image of said food product;
communicate said captured 3-D image and metadata associated with said 3-D image to said server; and
receive nutritional information associated with said food product based on said communicated metadata associated with said 3-D image.

22. The apparatus of claim 21, wherein said one or more processors and/or circuits are operable to recommend one or more of: at least one other food product similar to a type of one or more ingredients in said food product, alternate ingredients of said food product, a location to purchase said alternate ingredients, one or more restaurants serving said food product, and/or one or more grocery stores to purchase one or more ingredients in said food product.

23. The apparatus of claim 21, wherein said metadata corresponds to one or more of: a location data, a time of capturing said 3-D image, a name of said food product, a name of a restaurant serving said food product, and/or a location of said restaurant.
